(19) United States
(12) Patent Application Publication
(10) Pub. No.: US 2011/0050112 A1
(43) Pub. Date: Mar. 3, 2011

(54) FLICKERING CANDLE LED LIGHTING

(76) Inventor: John L. Janning, Bellbrook, OH (US)

(21) Appl. No.: 12/940,815

(22) Filed: Nov. 5, 2010

Related U.S. Application Data
(60) Provisional application No. 61/400,378, filed on Jul. 27, 2010.
(60) Provisional application No. 61/400,977, filed on Aug. 5, 2010.
(60) Provisional application No. 61/401,343, filed on Aug. 11, 2010.
(60) Provisional application No. 61/383,311, filed on Sep. 15, 2010.
(60) Provisional application No. 61/388,757, filed on Oct. 1, 2010.

(51) Int. Cl. H05B 37/02; F21S 4/00

(52) U.S. Cl. 315/185 R; 362/249.06

(57) ABSTRACT

A series-wired LED light string with flickering candle LED's. The LED's in the light string can be of the standard steady bum type or of the flickering type resembling a candle flame or the string can include a combination of both types as shown in FIG. 1. The flickering LED's each include a single Zener shunt to prevent variation of the voltage across the flickering LED, which would affect other LED's in the light string.

This application claims the benefit of Provisional Application Ser. No. 61/400,378, filed Jul. 27, 2010, Provisional Application Ser. No. 61/400,977, filed Aug. 5, 2010, Provisional Application Ser. No. 61/401,343, filed Aug. 11, 2010, Provisional Application Ser. No. 61/383,311 filed Sep. 15, 2010, and Provisional Application No. 61/388,757, filed Oct. 1, 2010.

### BACKGROUND OF THE INVENTION

Christmas light strings usually contain multiple bulbs electrically connected in a series-wired arrangement. A typical 50-light incandescent light string contains fifty 2.5 volt bulbs with a current rating of 170 milliamperes (mA). Recently, light strings have appeared on the market with lower current rated bulbs to save power. Some of these light strings use 80 milliampere bulbs while others use 100 milliampere bulbs.

For a further savings in power and cost, light emitting diode (LED) light strings have been developed in which a plurality of LED's are arranged in a series-wired arrangement. LED'S draw only approximately 20 mA and are therefore less costly to operate than incandescent bulb. Typically, LED light strings contain 35 bulbs. Recently, strings of 50 LED's have appeared on the market. One such string of 50 LED's is on the market under the GE Constant On label. It consists of 25 dual LED units where two LED's are wired in parallel and 25 of these units are wired in electrical series connection. Such a wiring arrangement, as taught by Li et al. in U.S. Pat. No. 7,045,965, provides for better reliability of the series-wired light string. If an LED in such a string would fail to operate, the string would still continue to function.

Flashing light strings are known, e.g., U.S. Patent Application Publication Nos. 2010/0148694 and 2010/00102735. However, it would be desirable to provide an LED light string that exhibits a flickering effect to simulate the look of a string of candles.

### SUMMARY OF THE INVENTION

The present invention provides a series-wired light string that exhibits a flickering candle effect. The light string of the present invention uses a unique LED device—one that flickers like a candle flame. The light string includes one or more of these flickering candle LED bulbs, making the light string to appear like it is fully or partially lit with candles.

Other features and advantages of the present invention will become apparent when the following description is read in conjunction with the accompanying drawings.

### BRIEF DESCRIPTION OF THE DRAWINGS

FIG. 1 is a schematic of the series-wired light string with flickering candle LED's of the present invention.

FIG. 2 is a schematic of a flickering candle LED unit used in the present invention, which consists of an LED and electronics to cause the LED to flicker like a candle.

FIG. 3 is a schematic of a series wired light string with flickering candle LED's and resistive shunts.

FIG. 4 is a schematic of a series wired light string with flickering candle LED's connected in a dual unit.

### DETAILED DESCRIPTION OF THE PREFERRED EMBODIMENTS

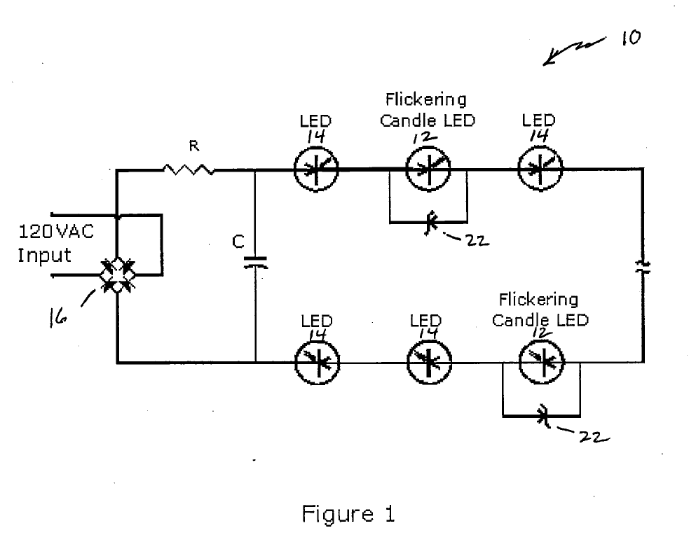

FIG. 1 is a schematic drawing showing the wiring of a series-wired LED light string 10 with flickering candle LED's 12 resembling a candle flame. The light string 10 can include not only flickering candle LED's, but also a combination of standard steady burn type LED's 14 and flickering candle LED's 12 as shown in FIG. 1. Such a light string placed on a Christmas tree gives the illusion of the Christmas tree being illuminated fully or partially with flickering candles.

The preferred input power is D.C., such as full wave rectified 120 volt alternating current. The light string is preferably powered by filtered DC (full wave bridge rectifier 16 and RC filter) as shown in FIG. 1. The resistor R is preferably approximately 22 ohms and the capacitor C is on the order of 5-10 microfarads. The resistor and capacitor are optional

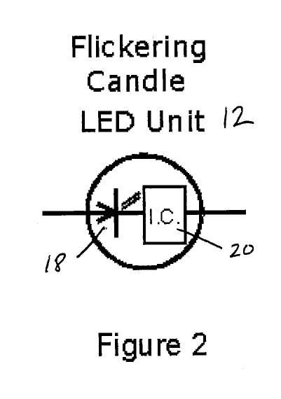

As shown in FIG. 2, each flickering candle LED 12 is actually a flickering LED circuit consisting of an LED 18 and electronics 20 to cause the LED to flicker like a candle. Preferably, as shown in FIG. 1, each flickering candle LED 12 includes a single Zener diode shunt 22 across the entire flickering LED circuit (i.e., across the LED 18 and the flickering electronics 20). Shunt 22 preferably consists of a single Zener diode (preferably 3.0 volt Zener). The purpose of Zener diode shunt 22 is to keep the voltage across the flickering candle LED 12 stable so as to avoid interference with the flickering mechanism in the LED. Without the Zener diode shunt across the flickering candle LED's, the flickering candle chip and LED circuitry causes slight voltage variations across the flickering candle LED circuitry, causing the remaining non-flickering LED's to flicker slightly. An approximate 3.0 volt Zener works well to arrest slight flickering of the remaining LED's.

The Zener diode voltage rating is preferably a few tenths of a volt less than the peak voltage appearing across the LED (if the Zener was not there). A Zener voltage rating slightly higher than the voltage across the flickering candle LED works fine—however, the preferred rating is slightly lower. Consideration of the Zener voltage should be given if too many flickering candle LED's are shunted by a Zener diode. For example, if all 35 LED's in a series-wired light string are shunted by a Zener diode, the Zener voltage rating should be around 5 volts. However, if ideally, only 20% or less, are shunted, 3.3 to 4.2 volt Zeners work fine.

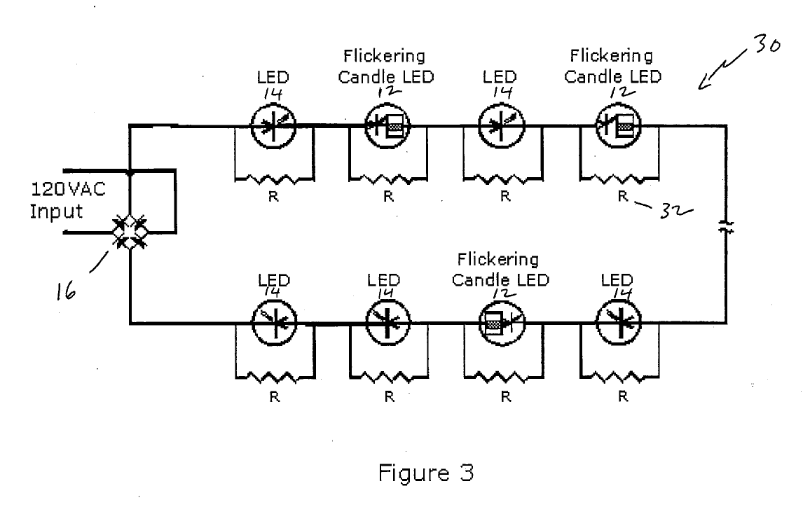

FIG. 3 shows a schematic of an alternative series wired light string 30 using resistive shunts 32 across the flickering LED's 12 and the non-flickering LED's 14. The resistor shunts 32 are ideally between 100 and 500 ohms.

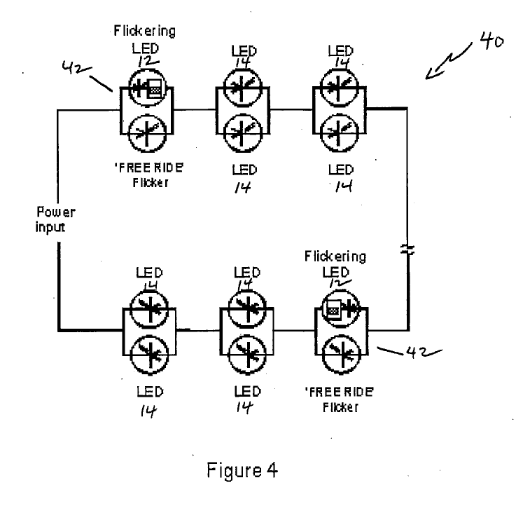

FIG. 4 shows a series wired flickering candle circuit 40 in which the flickering candle LED's 12 are connected in a dual unit 42, both LED's in that unit flicker. Therefore, one of the flickering candle LED's 12 of each dual unit 42 gets a “free ride” as a candle flickering (LED) device just by being connected across a true flickering candle LED in that unit.

A potential problem with all of the above-described embodiments is that the flickering candle LED's may not flicker if the ambient light around them is too bright. Accordingly, care should be taken to shield the light string from some of the surrounding light. Flickering LED candles (as opposed to light strings) which are currently on the market do not have this problem as the LED unit is well hidden. However, in a Christmas light string, the devices are typically exposed to higher ambient illumination. Therefore, care must be taken to reduce the illumination to which the device is exposed such that ambient light does not interfere with the proper operation of the string.

The flickering candle LED's of the present invention can have a “flame-shaped” cover over the LED's to disperse the light more uniformly and give the illusion the light is coming from a real candle. The cover can be made in a number of ways or shapes but is in any event designed to disperse the light from the flickering candle LED more uniformly than from a naked LED. The cover may also be made to look like a candle.

The Zener diode shunt can be installed in the flickering candle LED at the time of manufacture. By providing the shunt at this time would make light string manufacturing much easier and less costly.

The above description and drawings illustrate preferred embodiments which achieve the objects, features and advantages of the present invention. It is not intended that the present invention be limited to the illustrated embodiments, but rather only by the appended claims.

What is claimed is:

1. A series-wired light string, comprising:
a plurality of light sockets connected in electrical series; and
a plurality of flickering LED's, each disposed in a respective light socket of the light string, said flickering LED's flickering on and off at different rates and at different times to cause the flickering LED's in the light string to exhibit a flickering effect.

2. A series wired light string as recited in claim 1, wherein each of said flickering LED is a flickering LED circuit comprising an LED and associated electronics for causing the LED to flicker like a candle.

3. A series wired light string as recited in claim 2, wherein each flickering LED circuit is shunted by a Zener diode.

4. A series wired light string as recited in claim 2, wherein each flickering LED circuit is shunted by a resistor.

5. A series wired light string as recited in claim 1, further comprising a plurality of standard, non-flickering LED's disposed in respective ones of the light sockets.

6. A series wired light string as recited in claim 1, further comprising a full wave rectifier for converting AC power into DC power.

7. A series wired light string as recited in claim 6, further comprising a filter for the rectifier.

8. A series wired light string as recited in claim 1, wherein the flickering LED's have a flame shaped cover.

9. A series wired light string as recited in claim 1, wherein the flickering LED's of the light string are provided in dual units.

10. A series wired light string as recited in claim 9, further comprising a plurality of dual unit standard, non-flickering LED's in the light string.
